(19) United States
(12) Patent Application Publication
(10) Pub. No.: US 2002/0092406 A1
(43) Pub. Date: Jul. 18, 2002

(54) Percussion musical instrument

(75) Inventor: Takashi Hagiwara, Hamamatsu-shi (JP)

Correspondence Address: KODA & ANDROLIA, Suite 3850, 2029 Century Park East, Los Angeles, CA, 90067-3024, US

(73) Assignee: YAMAHA CORPORATION

(21) Appl. No.: 10/050,415

(22) Filed: Jan. 16, 2002

(30) Foreign Application Priority Data
Jan. 17, 2001 (JP) 2001-009122

(51) Int. Cl. G10D 13/02

(52) U.S. Cl. 84/411 R

(57) ABSTRACT

A percussion musical instrument including a drum head(s) installed on open end(s) of a trunk main body that is the main body of the percussion musical instrument, a hoop attached so as to surround the drum head that constitutes a striking surface, through-hole(s) formed in appropriate positions in the trunk main body, and bells positioned inside the through-holes and supported on shafts so that these bells can vibrate and sound.

### BACKGROUND OF THE INVENTION

1. Field of the Invention

The present invention relates to a percussion musical instrument of a drum configuration that creates various tone colors.

2. Prior Art

In basic configurations of conventional percussion musical instruments such as tom-toms, marching drums, snare drums, etc., as seen from FIG. 5, a trunk main body 101 is used as a main body thereof. The trunk main body 101 is formed by shaping a wooden laminated sheet, synthetic resin fiber material, light metal, etc., into a cylindrical form, and drum heads 102 made of natural leather, a synthetic resin film, etc., that are stretched at a uniform tension are installed at one or both open ends of the trunk main body 101 by head supporting and tensioning fittings (lugs) 103.

In the general method of playing used in such drums, the drumhead is struck with the tip end of a stick. In the case of rim shot playing, the rim of the drum is struck with an intermediate portion of the stick so that a sharp high sound is generated. However, in such percussion musical instruments, the expression of tonal gradations is inherently impossible, and only percussion sound is played. Accordingly, such musical instruments do not allow the expression of various playing modes.

### SUMMARY OF THE INVENTION

Accordingly, the object of the present invention is to provide a percussion musical instrument that generates various tone colors in accordance with the type of music involved, thus allowing various types of playing modes.

The above object is accomplished by a unique structure for a percussion musical instrument of the present invention in which a drum head is provided at one (or both) open end(s) of a trunk main body that is the main body of the percussion musical instrument, hoops are provided so as to surround the drum head(s) that constitutes a striking surface(s), an arbitrary number of through-holes are opened in appropriate positions in the trunk main body, and pairs of bells supported on shafts are provided inside the through-holes so that the bells can make a sound.

In the above structure, a snare assembly can be additionally installed inside the trunk main body so that acoustic wires of the snare assembly is brought into contact with the drumhead.

### BRIEF DESCRIPTION OF THE DRAWINGS

FIG. 1 is a perspective view of the percussion musical instrument according to one embodiment of the present invention;

FIG. 2 is a vertical cross-sectional view thereof;

FIG. 3 is a top plan view of the percussion musical instrument according to another embodiment of the present invention;

FIG. 4 is an enlarged partial sectional view thereof; and

FIG. 5 is a perspective view of a conventional percussion musical instrument of the drum configuration.

### DETAILED DESCRIPTION OF THE INVENTION

Embodiments of the present invention will be described in detail below with reference to the accompanying drawings. The embodiments will be described in terms of a drum of the tom-tom configuration. It should be noted, however, that the present invention is indeed applicable to a drum in which drum heads are set on both open ends of the trunk main body, as in a marching drum, snare drum, etc.

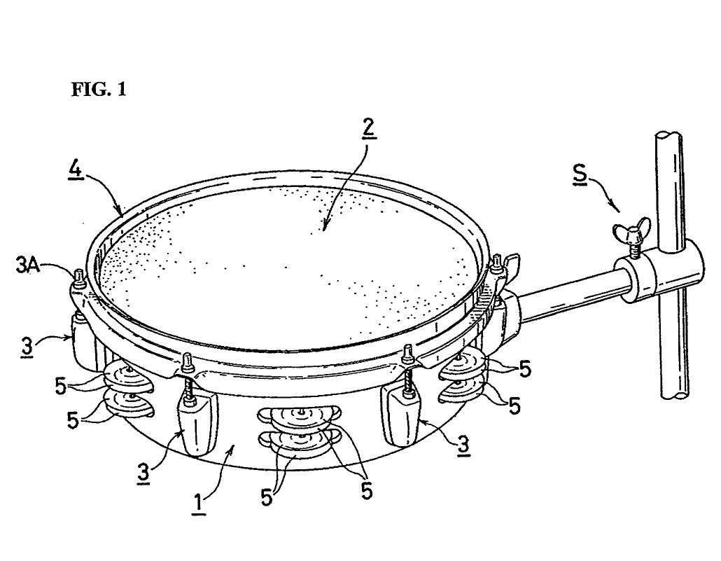

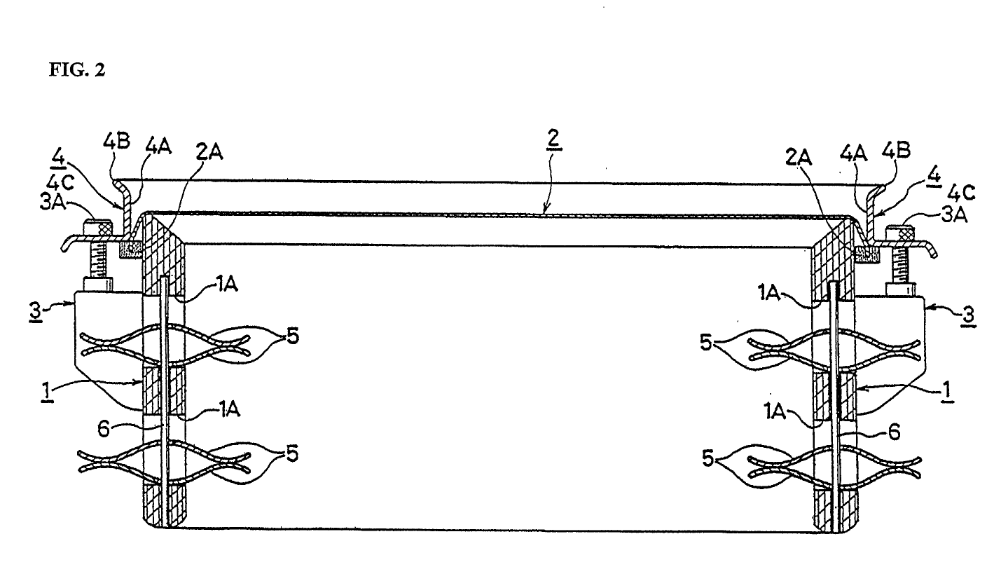

In FIGS. 1 and 2, the reference numeral 1 refers to a trunk main body that forms the main body of the drum. The same materials as used in conventional drums are used as the material for the trunk main body of the percussion musical instrument of the present invention. In the shown embodiment, a laminated wooden sheet is used. A drumhead 2 is provided on the top part of the open end of the trunk main body 1, and a head frame 2A is supported on the upper end portion of the outer circumferential wall surface of the trunk main body 1.

Lugs 3 are fastened to the outer circumferential wall surface of the trunk main body 1 by screws (not shown) that extend from the inner circumferential wall surface of the trunk main body 1 in a plurality of circumferential locations. A hoop 4 is provided so as to contact, at its angled portion 4C, the head frame 2A. The height of the hoop 4 relative to the drumhead 2 is adjusted by tightening screws 3A of the lugs 3, and thus the hoop 4 supports and stretches the drumhead 2 on the main body 1, thus rendering the drumhead 2 to form a striking surface. In the shown embodiment, the hoop 4 is attached on the main body 1 so that the upright wall 4A of the hoop 4 surrounds the drumhead 2 and protects the corner portion of the drumhead 2.

Furthermore, a plurality of through-holes 1A are formed in the circumferential wall of the trunk main body 1. Bells (bell plates) 5 which are disposed inside these respective through-holes are shaft-supported in a loose state on pins 6. In other words, the pins 6 are inserted into the trunk main body 1 from the bottom end of the trunk main body 1 and pass through the central portions of the through-holes 1A; and the bells 5 are mounted on the pins 6 somewhat loosely.

As a result, when the trunk main body 1 vibrates, the bells 5 are vibrated and make a sound inside the through-holes 1A. In the shown embodiment, the bells are disposed in two tiers in the axial direction of the trunk main body 1. It is indeed possible to employ a structure in which the bells are disposed in a single tier or in more than two tiers.

With the structure described above, when the instrument of the present invention is played, the instrument is set on a stand S as shown in FIG. 1 together with other percussion musical instruments such as drums, cymbals, etc. (not shown). When the player strikes the drum head 2 with the tip end of a stick in the general manner of playing, the drum head emits a sound, and the vibration propagated in the trunk main body 1 as a result of this striking is transmitted to the bells 5, and these bells 5 vibrate and make a sound. In other words, in the above-described manner of playing, a tone color in which the drumhead and bells emit sounds more or less simultaneously is obtained. On the other hand, in cases where the player strikes the edge 4B of the hoop 4 with an middle portion of the stick according to the rim shot playing method, a sharp high sound is emitted by the hoop 4, and the vibration propagated as a result of this striking is transmitted to the bells 5, and the bells 5 vibrate and make a sound. Thus, in this rim shot method, the tone color is that a metallic high sound and the sound of the bells are emitted more or less simultaneously.

The above-described percussion musical instrument can be added with acoustic wires.

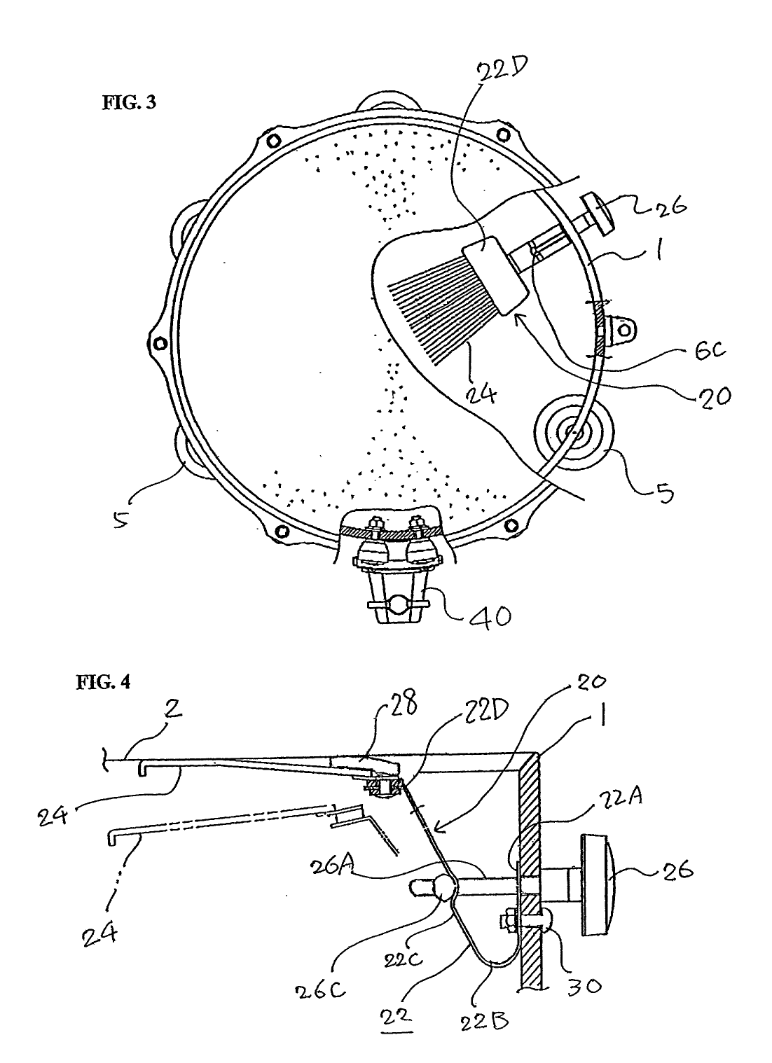

As seen from FIGS. 3 and 4, in this embodiment of the present invention, an acoustic wire assembly (or a snare assembly) 20 is installed inside the trunk main body 1 by way of a holding screw 30. The acoustic wire assembly 20 is comprised of a substantially L-shaped spring arm 22, a plurality of steel wires 24 attached to the upper end of the spring arm 22, and an adjustment screw 26. The spring arm 22 is substantially a spring band that is made of a metal and includes a root end 22A, a curved portion 22B that extends in an arc shape from the base end 22A and provides a spring function with the spring arm 22, a straight portion 22C that obliquely extends from the curved portion 22B and a head portion 22D that extends more or less horizontally from the straight portion 22D. The steel wires (or snares) 24 have a predetermined length and diameter and are securely attached side by side, as best seen from FIG. 3, to the head portion 22D of the spring arm 22. The steel wires 24 are substantially parallel to the drum head 2 as seen from FIG. 4, and end portions of the steel wires 34 are located near the center of the drum head 2 as seen from FIG. 3. A felt block 28 can be provided on the head portion 22D of the spring arm 22.

The spring arm 22 is mounted at its base portion 22A on the inner surface of the circumferential wall of the trunk main body 1 by a mount screw 30. The adjustment screw 26 that passes through a through hole (not shown) opened in the trunk main body 1 is connected to the spring arm 22. In other words, the shank 26A of the adjustment screw 26 passes through a connecting hole (not shown) opened in the middle portion of the straight portion 22C of the spring arm 22, and a nut 26C is screwed to the tip end of the shank 42.

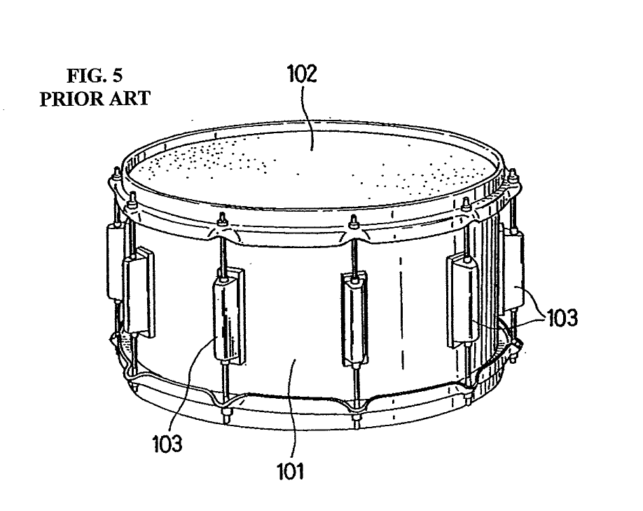

By way of turning the adjustment screw 26, the straight portion 22C of the spring arm 22 is pulled towards and pushed away from the trunk main body 1. When the adjustment screw 26 is turned in one direction and the spring arm 22 is pulled towards the trunk main body 1, the head portion 22D of the spring arm 22 approaches the drum head 2, and as a result the steel wires 25 are raised and come into contact with the drum head 2. The pressing strength of the steel wires 25 against the drumhead 2 is adjusted by way of fine turning of the adjustment screw 26. Raising the steel wires 25 increases contact to the drumhead 2, thereby increasing the amount of snare tone. When the adjustment screw 26 is turned in another direction and the spring arm 22 is pushed away from the trunk main body 1 as shown by two-dash dotted line in FIG. 5, the head portion 22D is lowered and the steel wires 25 are separated from the drumhead 2.

Thus, with the structure that involves the acoustic wire or snare assembly 20, the percussion musical instrument of the present invention produces further different tone color that is a combination of the sound of the drum head affected by the acoustic wire assembly and the bells.

In FIG. 3, the reference numeral 40 refers to a connecter for connecting the trunk main body 1 to the stand S. In the above description, the wires (snares) 24 are steel wires; however, the wires used in the present invention are not limited to steel wires. A wrapped wire for a guitar, an aramide fiber wire (Kevlar wire), a synthetic resin wire consisting of nylon, etc. can be used. Furthermore, the wires are not limited to rectilinear wires, and coil-form wires may be used. Also, the steel wires can be those that extend from one point to another point that is on the opposite side crossing the center of the drum head 2.

As seen from the above, according to the percussion musical instrument of the present invention, bells are caused to sound simultaneously with the sounding of the drumhead in an ordinary drum playing method, and a novel tone color is obtained. Various modes of playing a percussion musical instrument that have not been seen in the past are thus possible, and a significant playing effect is obtained.

1. A percussion musical instrument comprising:
a trunk main body that constitutes a main body of said percussion musical instrument;
a drumhead provided at least one open end of said trunk main body;
a hoop provided so as to surround said drumhead that constitute a striking surface;
at least one through-hole formed in said trunk main body; and
pairs of bells supported on a shaft provided inside said through-hole so that these bells can vibrate and sound.

2. The percussion musical instrument according to claim 1, further comprising an acoustic wire assembly provided inside said trunk main body so that acoustic wires of said acoustic wire assembly come into contact with and separated from said at least one drumhead.
